(19) United States
(12) Patent Application Publication
(10) Pub. No.: US 2022/0107524 A1
(43) Pub. Date: Apr. 7, 2022

(54) DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: HAO ZHAO, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/763,202

(22) PCT Filed: Apr. 10, 2020
(86) PCT No.: PCT/CN2020/084199

§ 371 Date: May 11, 2020

(30) Foreign Application Priority Data
Mar. 27, 2020 (CN) 202010232146.4

(51) Int. Cl. G02F 1/1343; G02F 1/1333; G02F 1/1335

(52) U.S. Cl. CPC G02F 1/13439; G06F 3/0412; G02F 1/133514; G02F 1/13338

(57) ABSTRACT

The present application discloses a display panel, including a driving module including a clock control module and a common voltage signal line electrically connected to the clock control module, wherein the common voltage signal line is input with a differential square wave signal; and a display module including a color filter substrate and a common electrode layer disposed on the color filter substrate, and the common electrode layer is electrically connected to the common voltage signal line.

### FIELD OF INVENTION

The present application relates to the field of display technology, in particular to a display panel.

### BACKGROUND OF INVENTION

At present, display devices with integrated touch function and display function are gaining popularity, has and have advantages of high sensitivity, fast response times, and multi-touch, etc. Common mutual-capacitance touch display panels adopt a one glass solution (OGS, single-chip touch) technology, an on-cell technology embedding capacitive touch function between a color filter substrate and a polarizer, and an in-cell technology embedding the capacitive touch function into a pixel.

At present, both on-cell technology and in-cell technology have an inevitable problem, that is, a disadvantage of poor anti-interference ability. Interference comes from voltage ripples in a common voltage signal line of display devices, which further affects stability of a touch signal line.

### Technical Problem

An embodiment of the present application provides a display panel, which is used to solve a technical problem of stability of touch function being affected due to voltage ripple interference in the common voltage signal line of the prior art.

### SUMMARY OF INVENTION

To solve the above technical problems, an embodiment of the present application provides a display panel, including: a driving module including a clock control module and a common voltage signal line electrically connected to the clock control module, wherein the common voltage signal line is input with a differential square wave signal, and the common voltage signal line includes a first signal line and a second signal line, and a phase of a first voltage signal in the first signal line is opposite to a phase of a second voltage signal in the second signal line; and a display module including a color filter substrate and a common electrode layer disposed on the color filter substrate, wherein the common electrode layer is electrically connected to the common voltage signal line.

In one embodiment of the present application, the first voltage signal and the second voltage signal are both square wave signals, and a frequency of the square wave signal is equal to a frame rate.

In one embodiment of the present application, the driving module further includes a circuit board, and the first signal line and the second signal line are connected in series with a resistance element on the circuit board.

In one embodiment of the present application, the driving module further includes an operational amplifier module, and the first signal line and the second signal line are both connected to the operational amplifier module to synthesize the first voltage signal and the second voltage signal into a third voltage signal, and output the third voltage signal to the common electrode layer.

In one embodiment of the present application, the third voltage signal is a direct-current (DC) voltage signal.

In one embodiment of the present application, the display module further includes an array substrate disposed opposite to the color filter substrate, and a liquid crystal layer disposed between the color filter substrate and the array substrate, and the common electrode layer is disposed between the color filter substrate and the liquid crystal layer.

In one embodiment of the present application, the display module further includes a touch module, and the touch module includes a plurality of first touch electrodes parallel to each other and a plurality of second touch electrodes parallel to each other, the plurality of first touch electrodes and the plurality of second touch electrodes cross each other to form a mutual capacitance structure.

In one embodiment of the present application, the plurality of first touch electrodes and the plurality of second touch electrodes are both disposed on a side of the color filter substrate facing away from the array substrate, each of the plurality of first touch electrodes includes a plurality of first electrodes spaced apart, and each of the plurality of second touch electrodes includes a plurality of second electrodes connected to each other, and the plurality of first electrodes are connected to each other by a bridge structure.

In one embodiment of the present application, the plurality of first touch electrodes are disposed between the color filter substrate and the common electrode layer, and the plurality of second touch electrodes are disposed between the array substrate and the liquid crystal layer.

A display panel is provided, including: a driving module including a clock control module and a common voltage signal line electrically connected to the clock control module, wherein the common voltage signal line is input with a differential square wave signal; and a display module including a color filter substrate and a common electrode layer disposed on the color filter substrate, and the common electrode layer is electrically connected to the common voltage signal line.

In one embodiment of the present application, the common voltage signal line includes a first signal line and a second signal line, and a phase of a first voltage signal in the first signal line is opposite to a phase of a second voltage signal in the second signal line.

In one embodiment of the present application, the first voltage signal and the second voltage signal are both square wave signals, and a frequency of the square wave signal is equal to a frame rate.

In one embodiment of the present application, the driving module further includes a circuit board, and the first signal line and the second signal line are connected in series with a resistance element on the circuit board.

In one embodiment of the present application, the driving module further includes an operational amplifier module, and the first signal line and the second signal line are both connected to the operational amplifier module to synthesize the first voltage signal and the second voltage signal into a third voltage signal and output the third voltage signal to the common electrode layer.

In one embodiment of the present application, the third voltage signal is a direct-current (DC) voltage signal.

In one embodiment of the present application, the display module further includes an array substrate disposed opposite to the color filter substrate and a liquid crystal layer disposed between the color filter substrate and the array substrate, and the common electrode layer is disposed between the color filter substrate and the liquid crystal layer.

In one embodiment of the present application, the display module further includes a touch module, and the touch module includes a plurality of first touch electrodes parallel to each other and a plurality of second touch electrodes parallel to each other, the plurality of first touch electrodes and the plurality of second touch electrodes cross each other to form a mutual capacitance structure.

In one embodiment of the present application, the plurality of first touch electrodes and the plurality of second touch electrodes are both disposed on a side of the color filter substrate facing away from the array substrate, each of the plurality of first touch electrodes includes a plurality of first electrodes spaced apart, and each of the plurality of second touch electrodes includes a plurality of second electrodes connected to each other, and the plurality of first electrodes are connected to each other by a bridge structure.

In one embodiment of the present application, the plurality of first touch electrodes are disposed between the color filter substrate and the common electrode layer, and the plurality of second touch electrodes are disposed between the array substrate and the liquid crystal layer.

### Beneficial Effect

Compared with the prior art, the present application reduces an influence of ripple interference in the common voltage signal line on the touch signal line by inputting differential square wave signals in the common voltage signal line, thereby improving the stability and anti-interference ability of the touch function in the display panel and further improving the touch performance of the display panel.

### DESCRIPTION OF DRAWINGS

The technical solutions and other beneficial effects of the present application will be obvious by the detailed description of the specific implementation of the present application with reference to the accompanying drawings.

FIG. 1 is a schematic structural diagram of a display panel driving circuit provided by an embodiment of the present application.

FIG. 2 is a timing diagram of a common voltage signal provided by an embodiment of this application.

FIG. 3 is a schematic structural diagram of a display panel provided by an embodiment of the present application.

FIG. 4 is a schematic structural diagram of another display panel provided by an embodiment of the present application.

### DETAILED DESCRIPTION OF PREFERRED EMBODIMENTS

The technical solutions in the embodiments of the present application will be described clearly and completely with reference to the drawings in the embodiments of the present application. Obviously, the embodiments are only a part of the embodiments of the present application, but not all the embodiments. Based on the embodiments of the present application, all other embodiments obtained by those skilled in the art without making creative work fall into the protection scope of the present application.

In the description of this application, it should be understood that the terms “center”, “longitudinal”, “lateral”, “length”, “width”, “thickness”, “above”, “below”, “front”, “back”, “left”, “right”, “vertical”, “horizontal”, “above”, “below”, “inner”, “outer”, “clockwise”, “counterclockwise”, etc. indicate the orientation or positional relationship are based on orientation or positional relationship shown in the drawings, just to facilitate the description of this application and simplify the description. It does not indicate or imply that the referred device or element must have a specific orientation, be constructed and operated in a specific orientation, and therefore cannot be construed as a limitation of the present application. In addition, the terms “first” and “second” are used for descriptive purposes only, and cannot be understood as indicating or implying relative importance or implicitly indicating the number of technical features indicated. Thus, the features defined as “first” and “second” may explicitly or implicitly include one or more of the features. In the description of this application, the meaning of “plurality” is two or more, unless otherwise specifically limited.

In the description of this application, it should be noted that the terms “installation”, “connected each other” and “connection” should be understood in a broad sense, unless otherwise clearly specified and limited. For example, it can be a fixed connection, a detachable connection, or an integral connection. It can be a mechanical connection, an electrical connection or can communicate with each other. It can be directly connected or indirectly connected through an intermediate medium. It can be the connection between two elements or the interaction between two elements. Those of ordinary skill in the art can understand the specific meanings of the above terms in this application according to specific situations.

In this application, unless otherwise clearly specified and defined, the first feature “on” or “below” the second feature includes the first feature and the second feature being in direct contact, it also includes that the first feature and the second feature are not in direct contact but are in contact through another feature between them. Moreover, the first feature is “above” and “on” the second feature includes that the first feature is directly above and obliquely above the second feature, or simply means that the first feature is higher in level than the second feature. The first feature is “below” and “under” the second feature includes that the first feature is directly below and obliquely below the second feature, or simply means that the first feature is less in level than the second feature.

The following disclosure provides many different embodiments or examples for implementing different structures of the present application. In order to simplify the disclosure of the present application, the components and settings of specific examples are described below. Of course, they are only examples, and the purpose is not to limit this application. Moreover, the present application may repeat reference numerals and/or reference letters in different examples. Such repetition is for simplicity and clarity and does not indicate the relationship between the various embodiments and/or settings discussed. In addition, the present application provides examples of various specific processes and materials, but those of ordinary skill in the art may be aware of the application of other processes and/or the use of other materials.

This application is directed to the technical problem of current display panel. That is, due to the voltage ripple interference in the common voltage signal line, the stability of the touch signal line is affected, which further affects the stability of the touch function of the display panel.

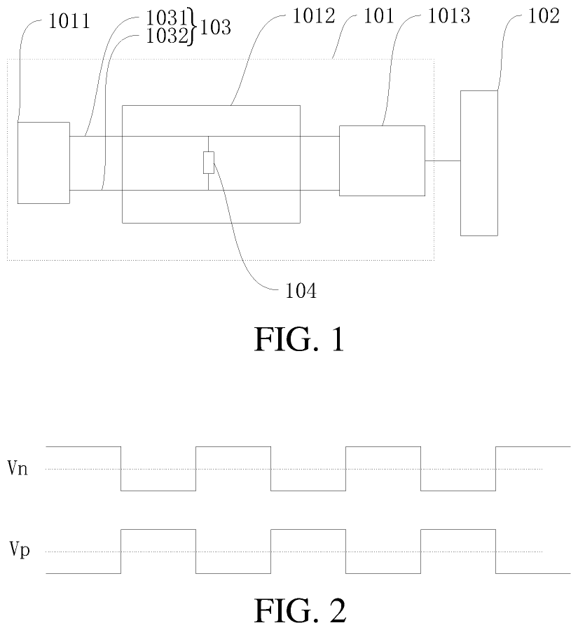

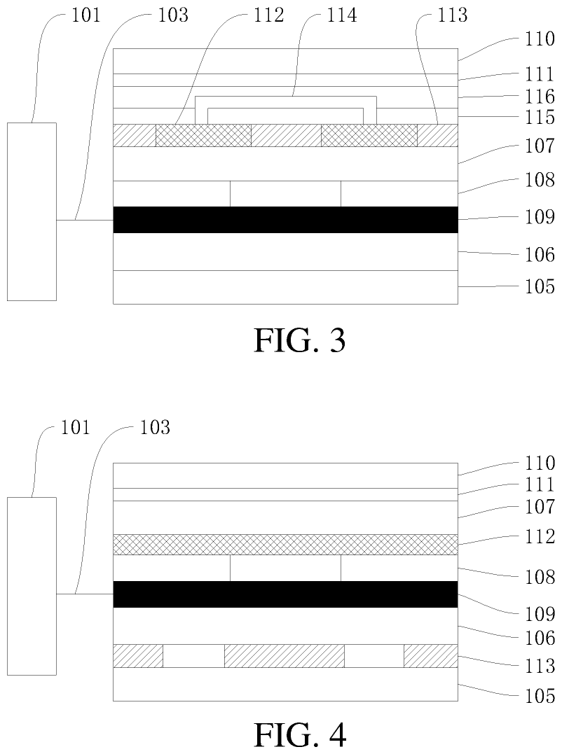

To solve the above technical problem, an embodiment of the present application provides a display panel, as shown in FIG. 1 and FIG. 3. The display panel includes a driving module 101 including a clock control module 1011 and a common voltage signal line 103 electrically connected to the clock control module 1011, wherein the common voltage signal line 103 is input with a differential square wave signal; and a display module 102 including a color filter substrate 107 and a common electrode layer 109 disposed on the color filter substrate 107, and the common electrode layer 109 is electrically connected to the common voltage signal line 103.

In the implementation and application, the touch function of current touch display panel has a disadvantage of poor anti-interference ability. Its interference comes from the voltage ripple in the common voltage signal line of the display panel, which affects the stability of the touch signal line, and further affects the stability of the touch function. However, the display panel provided by the embodiment of the present application can effectively reduce the interference of the common voltage signal on the touch signal and enhance the anti-interference ability of the mutual capacitance touch module by inputting the differential square wave signal into the common voltage signal line.

Specifically, referring to FIGS. 1, 2 and 3, the display panel includes a driving module 101 and a display module 102 electrically connected to the driving module 101.

The driving module includes a clock control module 1011, a circuit board 1012, and an operational amplifier module 1013, wherein the common voltage signal line 103 starts from the clock control module 1011, passes through the circuit board 1012 and the operational amplifier module 1013, and finally reaches the display module 102, and the differential square wave signal is input into the common voltage signal line 103.

It should be noted that the operational amplifier module 1013 can be located in a flip-chip thin film integrated circuit, and the operational amplifier module 1013 can be an operational amplifier, which can perform mathematical operations on the signal input to generate a new signal for output.

In addition, the driving module 101 is not limited to the common voltage signal line 103, and can also include a gate driving signal line, a source driving signal line, a touch signal line, and other functional data lines. The embodiment of the present application only shows the common voltage signal line 103 for illustration.

In the embodiment of the present application, the common voltage signal line 103 includes a first signal line 1031 and a second signal line 1032, and a phase of the first voltage signal Vₙ input in the first signal line 1031 is opposite to a phase of the second voltage signal Vₚ input in the second signal line 1032.

Furthermore, the first voltage signal Vₙ and the second voltage signal Vₚ are both square wave signals. As shown in FIG. 2, the first voltage signal Vₙ and the second voltage signal Vₚ have only maximum and minimum values and are switched within a certain frequency, and the switching frequency is equal to a frame frequency of the display panel, that is, the frequency of the square wave signal is equal to the frame frequency, but it is not limited to this, and can be selected according to an actual situation.

The first signal line 1031 and the second signal line 1032 are connected in series with a resistance element 104 on the circuit board 1012, and the resistance element 104 can reduce signal interference and play a role in stabilizing the voltage signal. Preferably, a resistance value of the resistance element 104 can be 100Ω.

The first signal line 1031 and the second signal line 1032 are then connected to the operational amplifier module 1013, and the first voltage signal Vₙ and the second voltage signal Vₚ are processed by an operational amplifier to obtain a third voltage signal. And the third voltage signal is input into the display module 102, that is, the third voltage signal is input to the common electrode layer 109 to input a common voltage signal to the common electrode layer 109, and the third voltage signal can be a DC voltage signal.

In one embodiment of the present application, please refer to FIG. 1 and FIG. 3, the display module 102 includes an array substrate 105 and a color filter substrate 107 disposed opposite to each other, and a liquid crystal layer 106 disposed between the array substrate 105 and the color filter substrate 107.

One side of the color filter substrate 107 facing the array substrate 105 is provided with a color filter layer 108 and a common electrode layer 109 in sequence, and the common electrode layer 109 is disposed between the color filter substrate 107 and the liquid crystal layer 106.

It should be noted that a thin film transistor device, a scanning line, a data line, a pixel electrode, and the like can be manufactured on the array substrate 105 according to a conventional process, which will not be repeated here in this embodiment.

A touch module is further provided on one side of the color filter substrate 107 facing away from the array substrate 105, and the touch module includes a plurality of first touch electrodes 112 parallel to each other and a plurality of second touch electrodes 113 parallel to each other, the plurality of first touch electrodes 112 and the plurality of second touch electrodes 113 cross each other to form a mutual capacitance structure, wherein the first touch electrodes 112 are not limited to being touch sensing electrodes or touch driving electrodes, and the second touch electrodes 113 are also not limited to being touch sensing electrodes or touch driving electrodes, and can be selected according to actual conditions.

In this embodiment, the plurality of first touch electrodes 112 and the plurality of second touch electrodes 113 are disposed in the same layer on the side of the color filter substrate 107 facing away from the array substrate 105. It should be noted that each of the plurality of first touch electrodes 112 includes a plurality of first electrodes arranged at intervals, and each of the plurality of second touch electrodes 113 includes a plurality of connected second electrodes, and the plurality of first electrodes are connected through a bridge structure 114. Specifically, one side of the color filter substrate 107 facing away from the array substrate 105 can further be provided with a first insulating layer 115 to cover the plurality of first touch electrodes, and the bridge structure 114 can be made to connect with the plurality of first electrodes via a through-hole to make to achieve mutual capacitance function between the plurality of first touch electrodes 112 and the plurality of second touch electrodes 113. Furthermore, a second insulating layer 116 may be disposed on the first insulating layer 115 to cover the bridge structure 114 and protect the touch module.

In addition, a cover 110 is further provided on the side of the color filter substrate 107 facing away from the array substrate 105, and the cover 110 adheres to the display module 102 by an optical adhesive 111.

In this embodiment, the driving module 101 inputs a common voltage signal to the common electrode layer 109 through the common voltage signal line 103, and the common voltage signal is input through the first signal line 1031 and the second signal line 1032 in a differential square wave signal manner, which can effectively reduce the interference of the common voltage signal on the touch signal, improve the stability of the touch signal line, and enhance the anti-interference ability of the mutual capacitance touch function.

In another embodiment of the present application, the difference from the above embodiment is only in the position of the touch module, the details are as follows: please refer to FIGS. 1 and 4, the display module 102 includes an array substrate 105 and a color filter substrate 107 oppositely disposed, and a liquid crystal layer 106 disposed between the array substrate 105 and the color filter substrate 107.

One side of the color filter substrate 107 facing the array substrate 105 is provided with a color filter layer 108 and a common electrode layer 109 in sequence, and the common electrode layer 109 is disposed between the color filter substrate 107 and the liquid crystal layer 106.

It should be noted that the thin film transistor device, the scanning line, the data line, the pixel electrode, and the like can be manufactured on the array substrate 105 according to a conventional process, which will not be repeated here in this embodiment.

The display module 102 further includes a touch module, and the touch module includes a plurality of first touch electrodes 112 parallel to each other and a plurality of second touch electrodes 113 parallel to each other. The plurality of first touch electrodes 112 and the plurality of second touch electrodes 113 cross each other to form a mutual capacitance structure, wherein the first touch electrodes 112 are not limited to being touch sensing electrodes or touch driving electrodes, and the second touch electrodes 113 are also not limited to being touch sensing electrodes or touch driving electrodes, and can be selected according to an actual situation.

In this embodiment, the plurality of first touch electrodes 112 are disposed between the color filter substrate 107 and the common electrode layer 109. Furthermore, the plurality of first touch electrodes 112 are disposed between the color filter substrate 107 and the color filter layer 108, and the plurality of second touch electrodes 113 are disposed between the array substrate 105 and the liquid crystal layer 106. Moreover, the arrangement directions of the plurality of first touch electrodes 112 and the plurality of second touch electrodes 113 are perpendicular to each other to achieve the mutual capacitance function.

In addition, a cover 110 is further disposed on the side of the color filter substrate 107 facing away from the array substrate 105, and the cover 110 adheres to the display module 102 by the optical adhesive 111.

In this embodiment, the driving module 101 inputs a common voltage signal to the common electrode layer 109 through the common voltage signal line 103, and the common voltage signal is input through the first signal line 1031 and the second signal line 1032 in a differential square wave signal manner, which can effectively reduce the interference of the common voltage signal on the touch signal, improve the stability of the touch signal line, and enhance the anti-interference ability of the mutual capacitance touch function.

In summary, the embodiments of the present application input differential square wave signals into the common voltage signal line to reduce the influence of ripple interference in the common voltage signal line on the touch signal line, improve the stability and anti-interference ability of the touch function in the display panel, and improve the touch performance of the display panel. In the above embodiments, the description of each embodiment has its own emphasis. For a part that is not detailed in one embodiment, you can refer to the related descriptions of other embodiments.

The display panel provided by the embodiments of the present application has been described in detail above, and specific examples have been used in this article to explain the principles and implementation of the present application. The descriptions of the above embodiments are only used to help understand the technical solutions and core ideas of the present application. Those of ordinary skill in the art should understand that the technical solutions described in the foregoing embodiments can be modified, or some of the technical features can be equivalently substituted. However, these modifications or substitutions do not deviate from the scope of the technical solutions in the embodiments of the present application.

What is claimed is:

1. A display panel, comprising:
a driving module comprising a clock control module and a common voltage signal line electrically connected to the clock control module, wherein the common voltage signal line is input with a differential square wave signal, the common voltage signal line comprises a first signal line and a second signal line, and a phase of a first voltage signal in the first signal line is opposite to a phase of a second voltage signal in the second signal line; and
a display module comprising a color filter substrate and a common electrode layer disposed on the color filter substrate, wherein the common electrode layer is electrically connected to the common voltage signal line.

2. The display panel according to claim 1, wherein the first voltage signal and the second voltage signal are both square wave signals, and a frequency of the square wave signal is equal to a frame rate.

3. The display panel according to claim 1, wherein the driving module further comprises a circuit board, and the first signal line and the second signal line are connected in series with a resistance element on the circuit board.

4. The display panel according to claim 1, wherein the driving module further comprises an operational amplifier module, and the first signal line and the second signal line are both connected to the operational amplifier module to synthesize the first voltage signal and the second voltage signal into a third voltage signal and output the third voltage signal to the common electrode layer.

5. The display panel according to claim 4, wherein the third voltage signal is a direct-current (DC) voltage signal.

6. The display panel according to claim 1, wherein the display module further comprises an array substrate disposed opposite to the color filter substrate and a liquid crystal layer disposed between the color filter substrate and the array substrate, and the common electrode layer is disposed between the color filter substrate and the liquid crystal layer.

7. The display panel according to claim 6, wherein the display module further comprises a touch module, the touch module comprises a plurality of first touch electrodes parallel to each other and a plurality of second touch electrodes parallel to each other, and the plurality of first touch electrodes and the plurality of second touch electrodes cross each other to form a mutual capacitance structure.

8. The display panel according to claim 7, wherein the plurality of first touch electrodes and the plurality of second touch electrodes are both disposed on a side of the color filter substrate facing away from the array substrate, each of the plurality of first touch electrodes comprises a plurality of first electrodes spaced apart, each of the plurality of second touch electrodes comprises a plurality of second electrodes connected to each other, and the plurality of first electrodes are connected to each other by a bridge structure.

9. The display panel according to claim 7, wherein the plurality of first touch electrodes are disposed between the color filter substrate and the common electrode layer, and the plurality of second touch electrodes are disposed between the array substrate and the liquid crystal layer.

10. A display panel, comprising:
a driving module comprising a clock control module and a common voltage signal line electrically connected to the clock control module, wherein the common voltage signal line is input with a differential square wave signal; and
a display module comprising a color filter substrate and a common electrode layer disposed on the color filter substrate, and the common electrode layer is electrically connected to the common voltage signal line.

11. The display panel according to claim 10, wherein the common voltage signal line comprises a first signal line and a second signal line, and a phase of a first voltage signal in the first signal line is opposite to a phase of a second voltage signal in the second signal line.

12. The display panel of claim 11, wherein the first voltage signal and the second voltage signal are both square wave signals, and a frequency of the square wave signal is equal to a frame rate.

13. The display panel of claim 11, wherein the driving module further comprises a circuit board, and the first signal line and the second signal line are connected in series with a resistance element on the circuit board.

14. The display panel of claim 11, wherein the driving module further comprises an operational amplifier module, and the first signal line and the second signal line are both connected to the operational amplifier module to synthesize the first voltage signal and the second voltage signal into a third voltage signal and output the third voltage signal to the common electrode layer.

15. The display panel according to claim 14, wherein the third voltage signal is a direct-current (DC) voltage signal.

16. The display panel according to claim 10, wherein the display module further comprises an array substrate disposed opposite to the color filter substrate and a liquid crystal layer disposed between the color filter substrate and the array substrate, and the common electrode layer is disposed between the color filter substrate and the liquid crystal layer.

17. The display panel of claim 16, wherein the display module further comprises a touch module, the touch module comprises a plurality of first touch electrodes parallel to each other and a plurality of second touch electrodes parallel to each other, and the plurality of first touch electrodes and the plurality of second touch electrodes cross each other to form a mutual capacitance structure.

18. The display panel of claim 17, wherein the plurality of first touch electrodes and the plurality of second touch electrodes are both disposed on a side of the color filter substrate facing away from the array substrate, each of the plurality of first touch electrodes comprises a plurality of first electrodes spaced apart, each of the plurality of second touch electrodes comprises a plurality of second electrodes connected to each other, and the plurality of first electrodes are connected to each other by a bridge structure.

19. The display panel of claim 17, wherein the plurality of first touch electrodes are disposed between the color filter substrate and the common electrode layer, and the plurality of second touch electrodes are disposed between the array substrate and the liquid crystal layer.
